(19) United States
(12) Patent Application Publication
(10) Pub. No.: US 2017/0269886 A1
(43) Pub. Date: Sep. 21, 2017

(54) IMAGE PROCESSING APPARATUS, IMAGE PROCESSING SYSTEM, AND RECORDING MEDIUM

(71) Applicant: Konica Minolta, Inc., Tokyo (JP)

(72) Inventor: Kaitaku OZAWA, Nishinomiya-shi (JP)

(73) Assignee: Konica Minolta, Inc., Tokyo (JP)

(21) Appl. No.: 15/452,152

(22) Filed: Mar. 7, 2017

(30) Foreign Application Priority Data
Mar. 18, 2016 (JP) 2016-056107

(51) Int. Cl. G06F 3/12; H04N 1/00; H04N 1/44

(52) U.S. Cl. CPC G06F 3/1238; G06F 3/1222; G06F 3/1203; G06F 3/1288; H04N 1/442; G06F 3/1273; H04N 1/00326; H04N 2201/0094; H04N 2201/006; H04N 2201/0055

(57) ABSTRACT

An image processing apparatus includes an acquisition part that acquires biological information on a user who makes the image processing apparatus execute a job, the biological information changing while reflecting a state of the user, and a registration control part that controls an operation for registering information on the job and the biological information on the user in association with each other.

The present U.S. patent application claims a priority under the Paris Convention of Japanese patent application No. 2016-056107 filed on Mar. 18, 2016, the entirety of which is incorporated herein by references.

### BACKGROUND OF THE INVENTION

Field of the Invention

The present invention relates to an image processing apparatus such as a multi-functional peripheral (MFP), and technologies concerning an image processing apparatus.

Description of the Background Art

In recent years, terminal devices that can be worn by users (hereinafter also referred to as wearable terminals or wearable devices) are becoming prevalent. In addition, some wearable terminals include a device for detecting physical information (e.g., pulse waves) on the user (such a device will also be referred to as a biological information detection device).

There is also a technique of simplifying a login operation by using biological information (specifically, a fingerprint, an iris, a vein, and the like) for identifying an individual in an image processing apparatus such as an MFP (refer to Japanese Patent Application Laid-Open No. 2008-33391).

In the meantime, in an image processing apparatus such as an MFP, various kinds of jobs (e.g., a copy job, a scan job, and a PC print job) are performed. With regard to these jobs, it is desirable to improve their operations and the like at all times.

However, it is not easy to collect information that leads to improvement of various jobs. It should be noted that the technique described in Japanese Patent Application Laid-Open No. 2008-33391 is a technique of identifying an individual by using biological information (specifically, a fingerprint, an iris, a vein, and the like) and of simplifying a login operation in an MFP, and is not a technique of collecting information leading to improvement of various jobs.

### SUMMARY OF THE INVENTION

An object of the present invention is to provide a technique capable of easily collecting information leading to job improvement.

A first aspect of the present invention provides an image processing apparatus including: an acquisition part that acquires biological information on a user who makes the image processing apparatus execute a job, the biological information changing while reflecting a state of the user; and a registration control part that controls an operation for registering information on the job and the biological information on the user in association with each other.

A second aspect of the present invention provides a non-transitory computer-readable recording medium for recording a program that causes a computer built in an image processing apparatus to execute: (a) acquiring biological information on a user who makes the image processing apparatus execute a job, the biological information changing while reflecting a state of the user; and (b) controlling an operation of registering information on the job and the biological information on the user in association with each other.

A third aspect of the present invention provides an image processing system including: an image processing apparatus; and a server. The image processing apparatus includes: an acquisition part that acquires biological information on a user who makes the image processing apparatus execute a job, the biological information changing while reflecting a state of the user; and a transmission part that transmits, to the server, job execution information in which information on the job and the biological information on the user are associated with each other. The server includes: a reception part that receives the job execution information from the image processing apparatus; and a storage part that stores the job execution information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an image processing system according to the present invention;

FIG. 2 shows functional blocks of an MFP (image processing apparatus);

FIG. 3 is a functional block diagram showing a schematic configuration of a wearable terminal;

FIG. 4 shows an outline of an operation concerning a copy job;

FIG. 5 is a timing chart showing the operation concerning the copy job;

FIG. 6 shows an outline of an operation concerning a scan job;

FIG. 7 is a timing chart showing the operation concerning the scan job;

FIG. 8 shows an outline of an operation concerning a print job (confidential print);

FIG. 9 is a timing chart showing the operation concerning the print job (confidential print);

FIG. 10 shows data in which jobs and biological information are registered in association with each other;

FIG. 11 shows another data in which jobs and biological information are registered in association with each other; and

FIG. 12 shows a modification example.

### DESCRIPTION OF THE PREFERRED EMBODIMENTS

Hereinafter, an embodiment of the present invention will be described with reference to the drawings. However, the scope of the invention is not limited to the illustrated examples.

### 1. First Embodiment

### 1-1. Configuration Outline

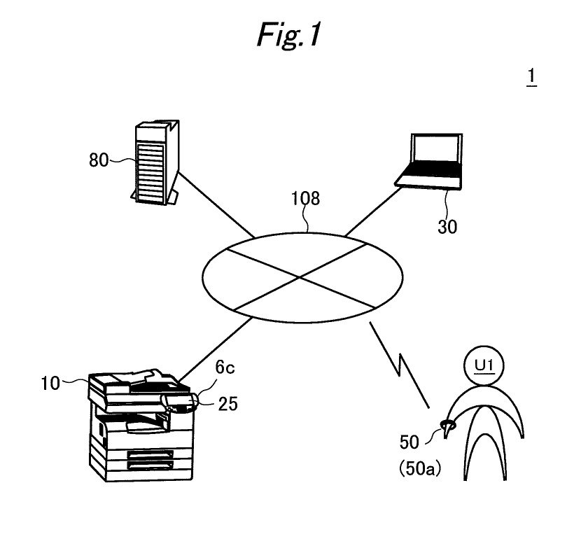

FIG. 1 shows an image processing system 1 according to the present invention. As shown in FIG. 1, the image processing system 1 includes an MFP (image processing apparatus) 10, a client computer 30, a wearable terminal 50, and a server computer 80.

The elements 10, 30, 50, and 80 in the present system 1 are connected communicably with each other via a network 108. The network 108 is configured by a local area network (LAN), the Internet, and the like. Further, the connection manner with respect to the network 108 may be a wired connection or a wireless connection.

Further, the MFP 10 and the wearable terminal 50 are wirelessly connected to each other using various wireless communication techniques. For example, for communication between the MFP 10 and the wearable terminal 50, communication using a wireless LAN (e.g., IEEE 802.11) and short-range wireless communication can be used. For example, communication based on Bluetooth (registered trademark) low energy (BLE), near field radio communication (NFC), or the like is used as the short-range wireless communication.

### 1-2. Configuration of Image Processing Apparatus

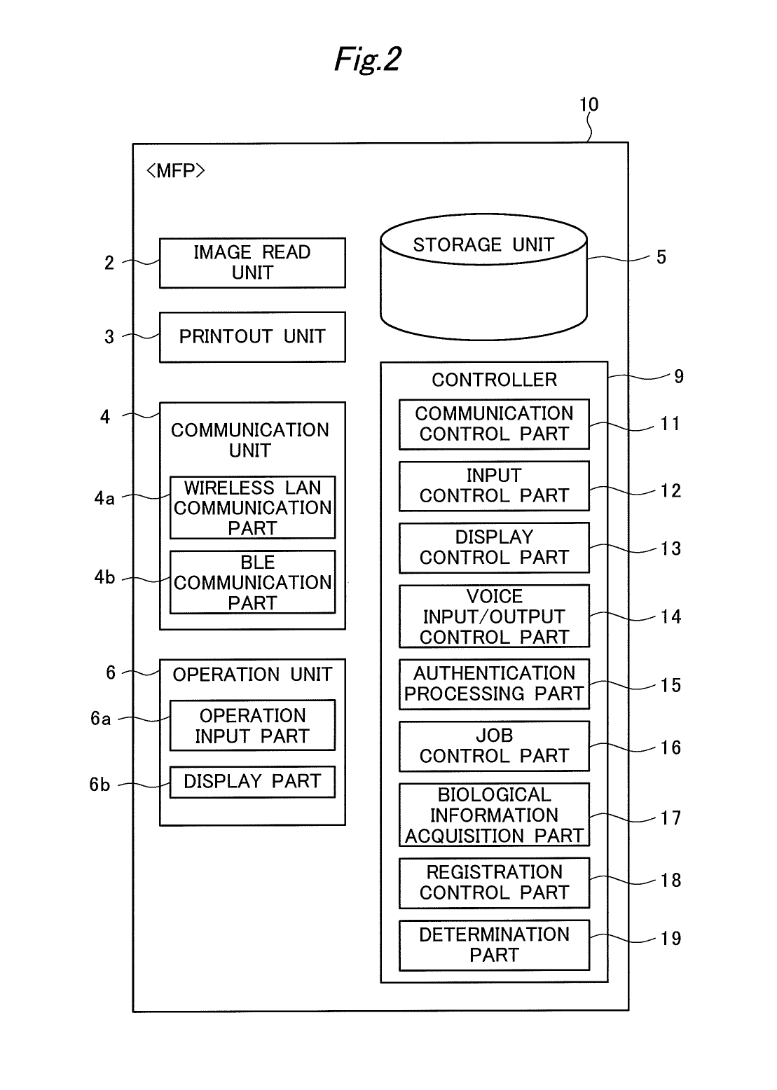

FIG. 2 shows functional blocks of the image processing apparatus 10. Here, a multi-functional peripheral (MFP) is exemplified as the image processing apparatus 10. FIG. 2 shows functional blocks of the MFP 10.

The MFP 10 is an apparatus (also referred to as a multi-functional peripheral) including a scan function, a copy function, a facsimile function, a box storage function, and the like. Specifically, as shown in the functional block diagram of FIG. 2, the MFP 10 includes an image read unit 2, a printout unit 3, a communication unit 4, a storage unit 5, an operation unit 6, a controller 9, and the like, and achieves various functions by operating these units in a combined manner. The MFP 10 is also referred to as an image forming apparatus.

The image read unit 2 is a processing unit that optically reads (i.e., scans) an original document placed on a predetermined position (e.g., an auto document feeder (ADF) or a glass surface) of the MFP 10 and generates image data of the original document (such data will also be referred to as an original image or a scanned image). This image read unit 2 is also called a scan unit.

The printout unit 3 is an output unit that prints and outputs an image on various media, such as paper, on the basis of data concerning the print target.

The communication unit 4 is a processing unit capable of performing facsimile communication via public lines or the like. Furthermore, the communication unit 4 can also perform various wireless communications. Specifically, the communication unit 4 includes a wireless LAN communication part 4a that performs wireless communication by a wireless LAN (e.g., IEEE 802.11) and a BLE communication part 4b that performs wireless communication by the BLE.

The storage unit 5 is configured of a storage device such as a hard disk drive (HDD).

The operation unit 6 includes an operation input part 6a for accepting an operation input to the MFP 10 and a display part 6b for conducting display output of various kinds of information.

The MFP 10 is provided with a substantially plate-shaped operation panel part 6c (see FIG. 1). Further, the operation panel part 6c has a touch panel 25 (see FIG. 1) on a front side thereof. The touch panel 25 functions as a portion of the operation input part 6a and also functions as a portion of the display part 6b. The touch panel 25 is configured by embedding various sensors and the like in a liquid crystal display panel, and can display various kinds of information and can accept various operation inputs from an operator.

The controller 9 is a control device built in the MFP 10 to comprehensively control the MFP 10. The controller 9 is configured as a computer system including a CPU, various semiconductor memories (e.g., a RAM, and a ROM), and the like. The controller 9 achieves various processing units by executing a predetermined software program (hereinafter also simply referred to as a program) stored in a ROM (e.g., an EEPROM) in the CPU. The program (specifically, a program module group) may be recorded on a portable recording medium such as a USB memory (in other words, various types of non-transitory computer-readable recording media) and read out from the recording medium to be installed in the MFP 10. Alternatively, the program may be downloaded via a network to be installed in the MFP 10.

As shown in FIG. 2, specifically, by executing the above program, the controller 9 achieves various types of processing units including a communication control part 11, an input control part 12, a display control part 13, a voice input/output control part 14, an authentication processing part 15, a job control part 16, a biological information acquisition part 17, a registration control part 18, and a determination part 19.

The communication control part 11 is a processing part that controls a communication operation with another device (e.g., the wearable terminal 50) by cooperating with the communication unit 4, and the like. The communication control part 11 has a transmission control part for controlling the transmitting operation of various kinds of data and a reception control part for controlling the receiving operation of various kinds of data.

The input control part 12 is a control part that controls the operation of an operational input to the operation input part 6a (e.g., the touch panel 25). For example, the input control part 12 controls the operation of accepting an operational input (e.g., a designation input from a user) on the operation screen displayed on the touch panel 25.

The display control part 13 is a processing part that controls the display operation on the display part 6b (e.g., the touch panel 25). The display control part 13 causes the touch panel 25 to display an operation screen or the like for operating the MFP 10.

The voice input/output control part 14 is a processing part that controls voice input processing by a voice input part (e.g., a microphone (not shown) built in the image processing apparatus 10), voice output processing by a voice output part (e.g., a speaker (not shown) built in the image processing apparatus 10), and the like.

The authentication processing part 15 is a processing part that controls authentication processing of the user (login processing).

The job control part 16 is a processing part that controls operations (e.g., a printout operation, and a scan operation) concerning various types of jobs.

The biological information acquisition part 17 is a processing part that acquires biological information on a user who makes the MFP 10 execute a job (in other words, a user of both the MFP 10 and the wearable terminal 50) in cooperation with the wearable terminal 50. The biological information will be described later.

The registration control part 18 is a processing part that controls an operation (registration operation) of registering the information on the job of the MFP 10 (specifically, the attribute information on the job (e.g., job type information and job setting information)) and the biological information on the user who makes the MFP 10 execute the job, in association with each other. For example, the registration control part 18 registers the biological information on the user in association with the information on each job, in a log (history information) concerning various jobs.

The determination part 19 is a processing part that determines the current mental state and the like of the user on the basis of the biological information on the user.

### 1-3. Configuration of Wearable Terminal 50

Next, the configuration of the wearable terminal (also referred to as a wearable device) 50 will be described.

The wearable terminal 50 is a device capable of performing cooperative operation with the MFP 10 (image processing apparatus). Specifically, the wearable terminal 50 is an information input/output terminal device (information terminal) capable of wireless communication (short-range wireless communication and network communication) with the MFP 10.

The wearable terminal 50 is a biological information detection device for detection (measurement) for biological information on the user (more specifically, biological information that changes while reflecting the state of the user (namely, dynamic biological information)). This embodiment exemplifies, as the wearable terminal 50, a device capable of detecting (measuring) the user's blood pressure as biological information on the user. However, the present invention is not limited to this example. The wearable terminal 50 may be a device for detection (measurement) for biological information other than a blood pressure (e.g., a pulse wave, an electrocardiogram, a body temperature, and/or a heart rate). The biological information is information that changes over time while reflecting a mental state and/or a physical condition of the user. It should be noted that the wearable terminal 50 is also referred to as a user state detection device or the like that detects a user's mental state or the like using the biological information on the user.

This embodiment exemplifies a wristband type (wrist-mounted type) device as the wearable terminal 50. However, the present invention is not limited to this example, and various types of devices can be used as the wearable terminal 50.

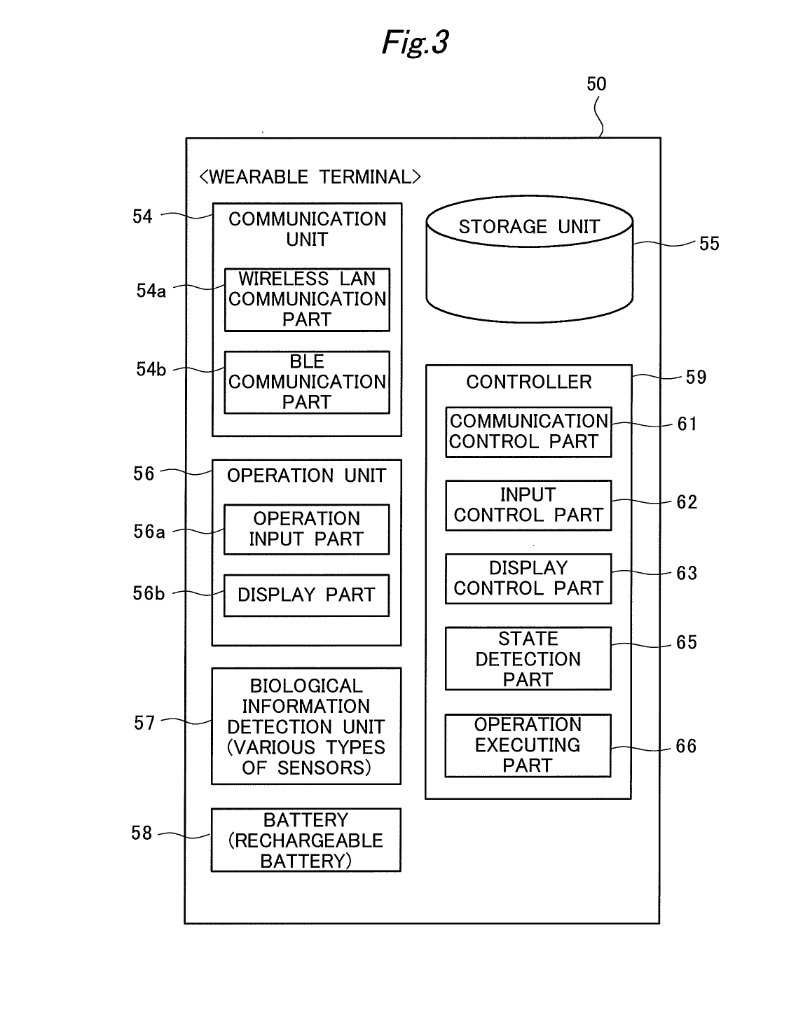

FIG. 3 is a functional block diagram showing a schematic configuration of the wearable terminal 50.

As shown in the functional block diagram of FIG. 3, the wearable terminal 50 includes a communication unit 54, a storage unit 55, a biological information detection unit 57, a battery 58, a controller 59, and the like, and operates these units in a combined manner, thereby achieving various functions.

The communication unit 54 can perform various types of wireless communication (including wireless communication by BLE, and other communications). Specifically, the communication unit 54 includes a wireless LAN communication part 54a that performs wireless communication by a wireless LAN (e.g., IEEE 802.11) and a BLE communication part 54b that performs wireless communication by BLE.

The storage unit 55 is configured by a storage device such as a nonvolatile semiconductor memory.

The biological information detection unit 57 is configured to include various sensors for detecting biological information such as a blood pressure.

The battery 58 is a secondary battery (rechargeable battery), and supplies power to the wearable terminal 50.

An operation unit 56 includes an operation input part 56a for accepting an operation input to the wearable terminal 50 and a display part 56b for display output of various kinds of information. The wearable terminal 50 is provided with a touch panel formed by embedding various sensors and the like in a liquid crystal display panel. The touch panel functions as a portion of the operation input part 56a and also functions as a portion of the display part 56b.

The controller 59 in FIG. 3 is a control device built in the wearable terminal 50 to comprehensively control the wearable terminal 50. The controller 59 is configured as a computer system including a CPU, various semiconductor memories (e.g., a RAM and a ROM), and the like. The controller 59 achieves various processing parts by executing a predetermined software program (hereinafter also simply referred to as a program) stored in the storage part (e.g., a semiconductor memory) in the CPU. The program (specifically, a program module group) may be recorded on a portable recording medium such as a USB memory (in other words, various types of non-transitory computer-readable recording media) and may be read out from the recording medium to be installed in the wearable terminal 50. Alternatively, the program may be downloaded via a network or the like to be installed in the wearable terminal 50.

The wearable terminal 50 has, for example, a program installed therein for cooperating with the MFP 10 (such a program will also be referred to as a program for cooperation). The program for cooperation is an application software program (also simply referred to as an application) for achieving various kinds of processing (e.g., processing of detecting a user's state (biological information), and processing of transmitting the user's state).

Specifically, the controller 59 achieves various processing parts including a communication control part 61, an input control part 62, a display control part 63, a state detection part 65, and an operation execution part 66, by executing the program for cooperation, and the like.

The communication control part 61 is a processing part that controls the communication operation with the MFP 10 and the like in cooperation with the communication unit 54 and the like.

The input control part 62 is a control part that controls the operation of an operational input to the operation input part 56a (e.g., a touch panel).

The display control part 63 is a processing part that controls the display operation on the display part 56b (e.g., a touch panel).

The state detection part 65 is a processing part for detection (measurement) for the biological information on the user, by cooperating with the biological information detection unit 57.

The operation execution part 66 is a processing part that collectively executes various cooperative operations with the MFP 10.

### 1-4. Other Devices

The client computer (also referred to simply as a client) 30 (see FIG. 1) is a computer capable of giving a printout command (e.g., a so-called PC print command) to the MFP 10. For example, the client computer 30 can transmit a print job (including printout data) concerning a desired document to the MFP 10 and can make the MFP 10 print out the document in response to an operation by the user U1.

The server computer 80 (also simply referred to as a server) is a computer for storing registration information (also referred to as “job history information” or “job execution information”) in which information on each job in the MFP 10 and biological information on the user who makes the MFP 10 execute each job are associated with each other. The job execution information generated by the MFP 10 is not only stored in the MFP 10, but also transmitted to the server 80 to be stored (accumulated) in the server 80. The server 80 may be a server provided in a business place where the MFP 10 is disposed or a server (e.g., a cloud server) provided outside the business place.

### 1-5. Operation Outline

<Copy Job Operation>

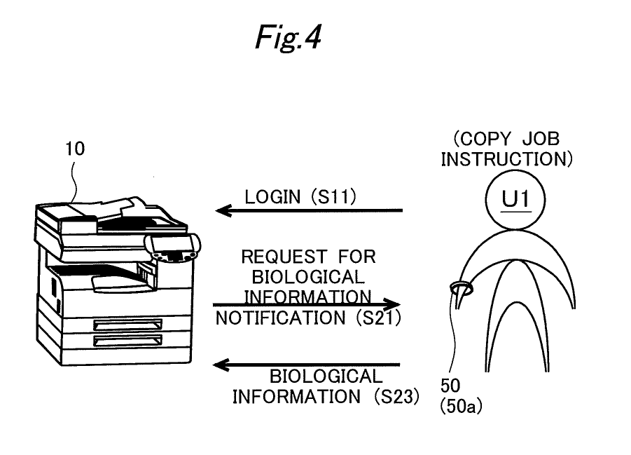

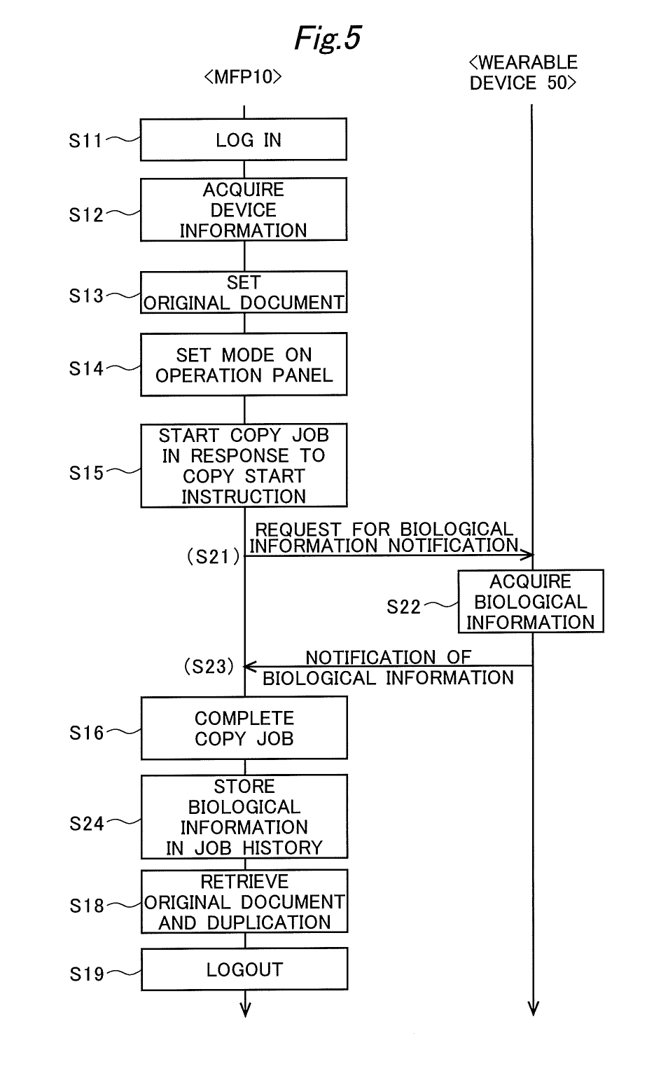

FIG. 4 shows operation in the present system 1, and more specifically, showing an outline of operation concerning a copy job. FIG. 5 is a timing chart showing the operation. The copy job operation will be described below.

Login processing is performed in step S11 (FIG. 5). Specifically, a user (e.g., the user U1) who wears the wearable terminal 50 operates the operation panel part 6c of the MFP 10 to input one's own user authentication information (e.g., a user ID and a password) on the login screen. In confirming that the inputted user authentication information is authorized, the MFP 10 permits the login of the user U1.

Next, in step S12, the MFP 10 acquires the device information on the wearable terminal 50 worn by the user U1. Specifically, user information in which the authorized login information (user authentication information) on the user U1 is associated with the device information on the wearable terminal 50 in advance is stored in the MFP 10, and the MFP 10 acquires the device information on the wearable terminal 50 of the login user U1 on the basis of the user information. Specifically, the device information (e.g., device identification information on the wearable terminal 50) stored in correspondence with the login user is extracted and acquired.

In this embodiment, user information in which the login information on the user U1 and the device information on the wearable terminal 50 are associated with each other in advance is stored in the MFP 10; however, the present invention is not limited thereto. The user information may be stored in the server 80. The MFP 10 may communicate with the server 80 to acquire from the server 80 the user information (in particular, the device information) stored in the server 80.

In step S13, the user U1 places an original document to be copied on the MFP 10 (e.g., the glass surface or the ADF). In step S14, the user U1 makes the MFP 10 execute various setting operations concerning the copy job, using the operation panel part 6c.

In completion of various setting operations concerning the copy job, the user U1 gives a copy start instruction to the MFP 10 by pressing the start button (not shown) of the operation panel part 6c.

In response to the copy start instruction, the MFP 10 starts the copy operation (step S15). Specifically, the MFP 10 starts, for example, processing of generating a read image of the original document.

Immediately after the start of the copy operation, the MFP 10 communicates with the wearable terminal 50 to acquire the biological information on the user U1 (steps S21 to S23). Specifically, the MFP 10 acquires biological information obtained by measurement of the wearable terminal 50 (wearable device) worn by the user U1 from the wearable terminal 50 through communication with the wearable terminal 50.

Specifically, first, the MFP 10 transmits a biological information notification request to the wearable terminal 50 (step S21). Next, in receiving the biological information notification request, the wearable terminal 50 conducts measurement (detection) to obtain the biological information on the user U1 using the biological information detection unit 57 (step S22). Next, the wearable terminal 50 transmits the obtained biological information (i.e., the biological information on the user U1) to the MFP 10 (step S23). The MFP 10 may communicate with the wearable terminal 50 by using the device information received in advance in step S12.

Thereafter, when the copying processing (processing of scanning the original document to generate a scanned image and executing a printout based on the scanned image) is completed (step S16), the MFP 10 registers the biological information received in step S23 in association with the copy job, in the job history information (step S24).

Specifically, the MFP 10 stores (registers) the information in which the information on the job to be executed is associated with the biological information on the user who makes the MFP 10 execute the job, in the storage unit 5 of the MFP 10 as job history information (job execution information). Further, the MFP 10 transmits the job history information (job execution information) to the server 80 and stores (registers) the job history information (job execution information) in the server 80. In this manner, the MFP 10 performs an operation of registering the job history information (job execution information) in both the MFP 10 and the server 80.

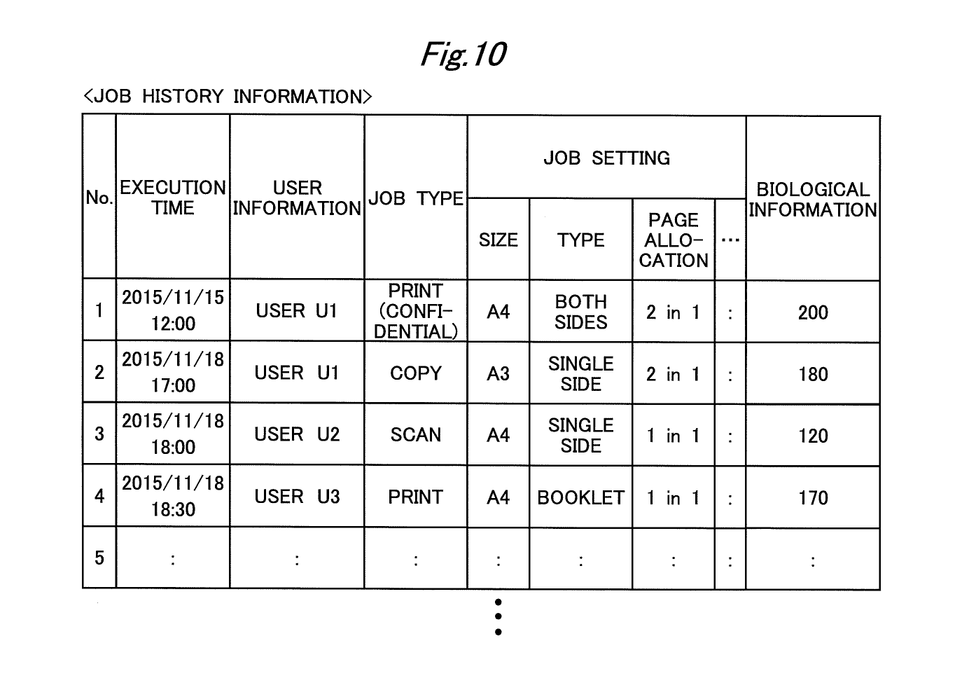

FIG. 10 shows an example of the job history information. As shown in FIG. 10, the job history information has pieces of information concerning the execution time of the job, the user who makes the MFP 10 execute the job, the job type, and the job setting, and also has the biological information acquired in steps S21 to S23.

For example, the second column from the top of FIG. 10 shows the following information on the job. Specifically, information (job information) concerning the execution time of the job (“2015/11/18 17:00”), the user who makes the MFP 10 execute the job (“user U1”), the job type of the job (“copy”), and the job setting of the job (e.g., paper size=“A3”, type=“single side copy”, page allocation=“2 in 1”) is registered. In addition to the job information, biological information (e.g., blood pressure=“180” (mmHg)) is registered. In other words, information on the job (e.g., job type information and job setting information) and the biological information on the user are registered in association with each other.

In step S18, next, the user U1 retrieves the original document (copy base document) (take out from the MFP 10) and also retrieves the copy document (duplicate).

In step S19, the user U1 executes a logout operation from the MFP 10 to log out of the MFP 10.

According to the operation described above, since the biological information on the user who is making the MFP 10 execute the copy job is acquired and the biological information and the information on the copy job are registered in association with each other, information leading to job improvement can be easily collected.

<Scan Job Operation>

Next, the scan job operation will be described.

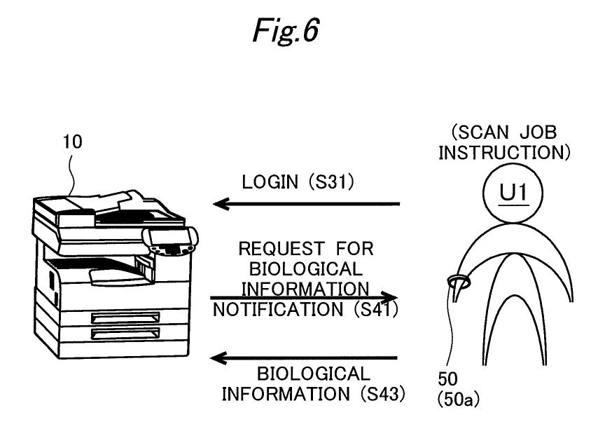

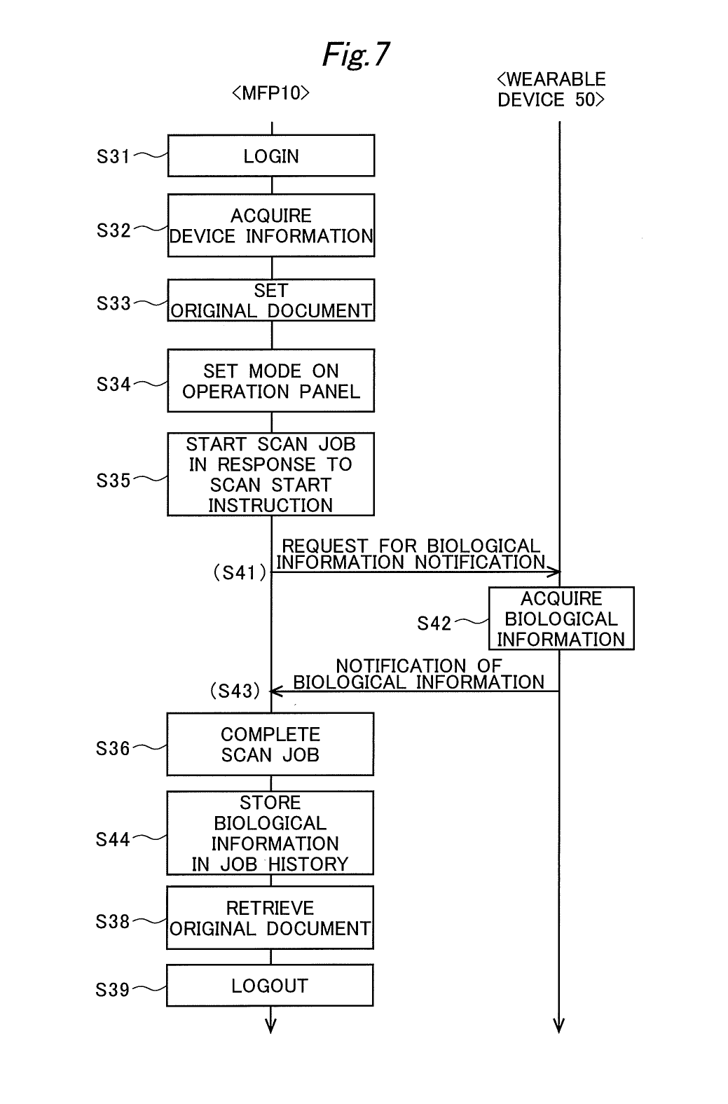

FIG. 6 shows operation in the present system 1, and more specifically, showing an outline of operation concerning a scan job. FIG. 7 is a timing chart showing the operation.

The scan job operation is executed in the same manner as the copy operation. In steps S31 to S39 and S41 to S44 of FIG. 7, processes similar to those in steps S11 to S19 and S21 to S24 in FIG. 5 are performed respectively. However, in the scan job, the printout processing for the read image (scanned image) is not executed, but instead, the processing of generating and storing the data file based on the read image is executed.

As a result of the registration operation in step S44, for example, information shown in the third column from the top of FIG. 10 is registered. Specifically, information (job information) concerning the execution time of the job (scan job) (“2015/11/18 18:00”), the user who makes the MFP 10 execute the job (“user U2”), the job type of the job (“scan”), and the job setting of the job (e.g., paper size=“A4”, type=“single side (reading)”, page allocation=“1 in 1”) is registered. In addition to the job information, biological information (e.g., blood pressure=“120”) is registered.

According to the operation described above, since the biological information on the user who is making the MFP 10 execute the scan job is acquired and the biological information and the information on the scan job are registered in association with each other, information leading to job improvement can be easily collected.

<Print Job Operation>

Next, the print job operation will be described.

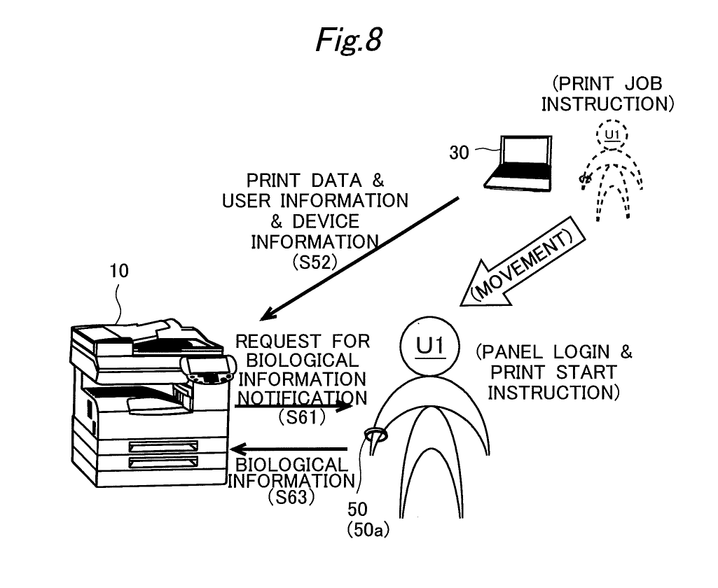

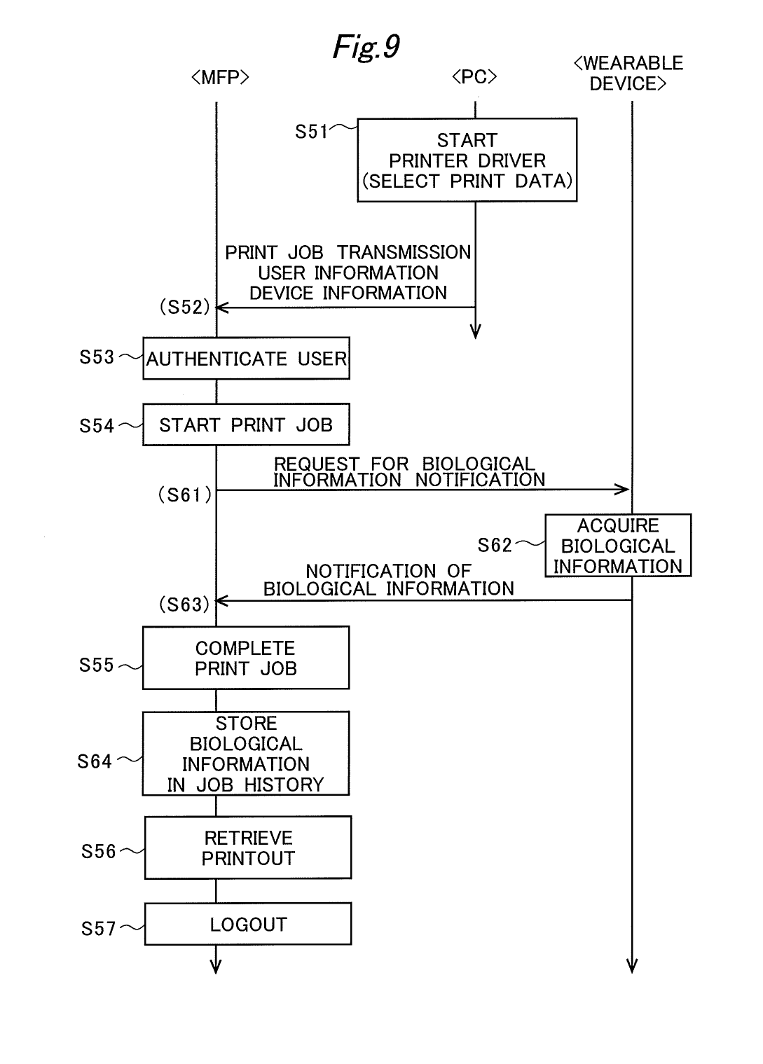

FIG. 8 shows operation in the present system 1, specifically, an outline of operation concerning a print job (more specifically, confidential print job). FIG. 9 is a timing chart showing the operation.

The “confidential print job” is a printing method different from a usual PC print job, and is a printing method for the purpose of, for example, preventing other persons from viewing the printed matters. In the confidential print job, even when print data is transmitted from the computer (print request source device) 30 (more specifically, printer driver) to the MFP 10 according to the user's operation, the printout based on the print data is not immediately executed. Thereafter, the printout based on the print data is executed under condition that the print start instruction is given again using the operation panel part 6c after the user has moved to the place where the MFP 10 is placed and the user is authenticated by the login processing (authentication processing) using the operation panel part 6c of the MFP 10.

First, in step S51 (FIG. 9), a user (e.g., the user U1) who wears the wearable terminal 50 operates the client 30 to activate the printer driver in the client 30 and to give a confidential print instruction. Specifically, the user gives a confidential print instruction with the desired electronic data designated as a print target, and the client 30 accepts the confidential print instruction.

In step S52, the client 30 transmits the print data and the user information (e.g., the user ID of the user U1) and the device information (e.g., the device identification information on the wearable terminal 50) to the MFP 10 in response to the confidential print instruction. It is assumed that the user information and the device information are registered in the printer driver in advance.

The MFP 10 temporarily stores the print data and the like received from the client 30, in the storage unit 5.

Thereafter, the user U1 moves to the installation location of the MFP 10 from the installation location of the client 30 in order to make the MFP 10 to execute a printout concerning the confidential print job.

In step S53, the user U1 executes a user authentication operation using the operation panel part 6c of the MFP 10 to log in to the MFP 10. Specifically, the user U1 inputs one's own user authentication information (e.g., a user ID and a password) on the login screen, and when the MFP 10 has confirmed that the inputted user authentication information is authorized, the MFP 10 permits the login of the user U1.

Thereafter, the user U1 operates the operation panel part 6c to display a list screen concerning the confidential print on the touch panel 25, and selects a desired data file (document) as a printout target from a plurality of data files in the list screen. Further, the user U1 presses the start button. The MFP 10 starts a printout (step S54) in response to the pressing of the start button (giving a print start instruction).

Further, immediately after starting the printout, the MFP 10 communicates with the wearable terminal 50 to acquire the biological information on the user U1 (steps S61 to S63).

Specifically, first, the MFP 10 transmits a biological information notification request to the wearable terminal 50 (step S61). Next, in receiving the biological information notification request, the wearable terminal 50 obtains the biological information on the user U1 by measurement using the biological information detection unit 57 (step S62). Next, the wearable terminal 50 transmits the obtained biological information (the biological information on the user U1) to the MFP 10 (step S63). The communication between the MFP 10 and the wearable terminal 50 may be performed using previously received device information.

Thereafter, when the printout is completed (step S55), the MFP 10 registers the biological information received in step S63 in association with the copy job, in the job history information (step S64).

Specifically, the MFP 10 stores (registers) information in which a job to be executed is associated with biological information on the user who makes the MFP 10 execute the job, in the storage unit 5 of the MFP 10 as job history information (job execution information). Further, the MFP 10 transmits the job history information (job execution information) to the server 80 and stores (registers) the job history information in the server 80. In this manner, the MFP 10 performs an operation of registering the job history information (job execution information) in both the MFP 10 and the server 80.

As a result of the registration operation in step S64, for example, information shown in the first column from the top of FIG. 10 is registered. Specifically, information (attribute information) on the job execution time (a printout time in a confidential print job) (“2015/11/15 12:00”), the user who makes the MFP 10 execute the job (“user U1”), the job type of the job (“print”), and the job setting of the job (e.g., paper size=“A4”, type=“both sides (print)”, page allocation=“2 in 1”) is registered. In addition to the job information (attribute information), the biological information (e.g., blood pressure=“200”) is registered.

This embodiment exemplifies a confidential print job as the print job; however, the present invention is not limited to this example. For example, the biological information on the user may be registered in association with a print job (e.g., a so-called usual PC print job) in which a printout is immediately started in response to an instruction from the client 30, without user authentication by the operation panel part 6c. In this case, the MFP 10 may also receive device information together with print data from the client 30 (printer driver) and communicate with the wearable terminal 50 using the device information.

### 1-6. Effects of the Present Embodiment and Others

As described above, in the foregoing embodiment, the biological information on the user (e.g., the user U1, the user U2, the user U3) who makes the MFP 10 execute the job is registered in association with the job in the job history information (job execution information) (see FIG. 10). Therefore, information leading to job improvement can be easily collected. More specifically, since the user's mental state and the like in the job can be known, it is possible to recognize, for example, the user's anxious state (e.g., a state where the user feels stress and/or dissatisfaction) for finding out whether the job has a problem (for extracting issues of the job) and for examining improvement points of the job. As a result, customer satisfaction can be improved.

Further, the information registered in the MFP 10 is also transmitted to and registered in the server 80. Furthermore, by repeating the same operations, the server 80 accumulates a plurality of pieces of biological information concerning a plurality of jobs.

In particular, because of the registration of a plurality (preferably a large number) of pieces of biological information concerning a plurality (preferably a large number) of jobs of the same type or different types, the characteristics of the general mental state and the like of the user in the respective jobs can be grasped on the basis of the relationship between the plurality of pieces of biological information and the job information. In other words, by knowing the user state for each job, improvement points peculiar to a certain job can be found.

The number of persons (users) to be measured in each job may be one but is preferably two or more. By registering biological information on a plurality of users in each job, not a tendency relying on a specific user but a tendency not relying on a specific user (i.e., a tendency of biological information on a plurality of biological objects) can be known. That is, dependence on users can be eliminated and more general trends can be acquired.

Further, in particular, by registering attribute information on the job (job type information and/or job setting information) in association with the biological information on the user as the job information, the problem (improvement points) and the like for each piece of attribute information on the job can be found.

Specifically, when the fact is grasped that the average value of the biological information on the user (e.g., the average value of the blood pressure) concerning a specific type of job (e.g., a print job) is higher than the average value of the biological information on the user concerning another type of job (e.g., copy job) (i.e., there is a large deviation from the normal value), it is estimated that there is room for improvement in the specific type of job.

When the fact is grasped that the average value of the biological information on the user (e.g., the average value of the blood pressure) concerning a job involving a particular setting (e.g., a “2 in 1” print job) is higher than the average value of the biological information on the user concerning a job involving another setting (e.g., a “1 in 1” print job) (i.e., there is a large deviation from the normal value), it is estimated that there is room for improvement in the job involving the specific setting.

Further, in the foregoing embodiment, since the biological information on the user in each job is obtained by measurement at a certain specific stage (specific timing) determined for each type of job, variation in the measurement timing for biological information can be avoided in a certain job type. As a result, variation in measurement results for biological information due to variation in the measurement timing can be avoided. That is, a plurality of measurement results (biological information) concerning a certain job type can be acquired under equalized conditions.

### 1-7. Modification Example of First Embodiment

<Other Specific Measurement Timing Regarding Biological Information>

In the first embodiment, the biological information on the user who make the MFP 10 execute the copy job is obtained by measurement at a specific timing (specific stage) (more specifically, at the start of copying operation); however, the present invention is not limited thereto. The biological information on the user may be obtained by measurement at another specific timing.

For example, the other specific timing may be the login time point (step S11) or the original document placement time point (step S13). The other specific timing may also be a time point immediately after the document is placed and the setting operation concerning the job is started (at the start of step S14) or a time point immediately after the document is placed and the setting operation concerning the job is completed (at the end of step S14). The other specified timing may alternatively be the time point of completion of copying (step S16). The other specified timing may alternatively be the time point of retrieval of the original document and the printed matter (copy) (step S18) or the logout time point (step S19). In this case, the process of step S24 may be performed after step S18 or S19.

The time points of the original document placement and document retrieval may be determined on the basis of the presence or absence of the document detection by a document detection sensor provided on the ADF or the glass surface. Similarly, the time point of the collection of the printout matter (copy) may be determined on the basis of the presence or absence of paper detection by a paper discharge detection sensor provided in a sheet feeder.

Alternatively, the specific timing may be a time point after a predetermined time has elapsed after completion of the job. When an abnormal value (e.g., an abnormal value of a detection value indicating biological information) is detected at a time point after the lapse of a predetermined time after the completion of the job, it is presumed that there is a high possibility that an output result of the job against the user's intention has been obtained. In other words, it is estimated that, for example, the user is upset by viewing the output result of the copy job (dissatisfied with the copy output result).

As described above, the timing of measurement for the biological information on the user may be an appropriate time point within a series of operation periods concerning the job executed by the user (specifically, from the time immediately before the execution of the job (e.g., the login time point for the job execution (step S11)) to the time immediately after execution of the job (e.g., the logout time point accompanying the completion of the job execution (step S19))).

Further, as described above, by considering also that a large number of abnormal values (detection values indicating biological information) are detected in a copy job involving a specific setting (e.g., “N in 1” (such as “2 in 1”)), it is also determined, for example, whether there is room for improvement in the specific job setting.

In the first embodiment, the biological information on the user who makes the MFP 10 execute the scan job is obtained by measurement at a certain specific timing (specifically, at the start of the scan operation); however, the present invention is not limited thereto. The biological information on the user may be obtained by measurement at another specific timing.

For example, the other specific timing may be the login time point (step S31) or the document placement time point (step S33). The other specific timing may also be a time point immediately after the original document is placed and the setting operation concerning the job is started (the start of step S34) or a time point immediately after the document is placed and the setting operation concerning the job is completed (more specifically, at the time when the scan start instruction is completed) (at the end of step S34). The other specific timing may alternatively be the scan completion time point (step S36). The other specific timing may alternatively be the time point of the original document retrieval (step S38) or the logout time point (step S39). In this case, the process of step S44 may be performed after step S38 or S39.

In the first embodiment, the biological information on the user who makes to the MFP 10 execute the print job is obtained by measurement at a certain specific timing (specifically, after the start of the printout); however, the present invention is not limited thereto. The biological information on the user may be obtained by measurement at another specific timing. For example, the other specific timing may be a time point immediately after receiving the device information and the like in step S52. The other specific timing may alternatively be a time point immediately after the user U1 logs in to the MFP 10 using the operation panel part 6c of the MFP 10 in step S53. The other specific timing may alternatively be the time point of printing completion (step S55). The other specific timing may alternatively be the time point of printed matter retrieval (step S56) or the logout time point (step S57). In this case, the process of step S64 may be performed after step S56 or S57.

Further, the biological information on the user is not limited to biological information to be obtained by measurement during the job execution by the user. For example, as described above, the biological information on the user may be obtained by measurement immediately before the execution (e.g., the login time point) and/or immediately after the execution (e.g., the logout time point) of the job by the user.

<Plurality of Specific Timings, and Others>

In the first embodiment and the like, as biological information on a user who makes the MFP 10 execute a certain job, a single piece of biological information is obtained by measurement at a single time point in a series of operation periods concerning the job, and only the single piece of biological information is registered in association with the one job; however, the present invention is not limited thereto.

For example, as biological information on a user who makes the MFP 10 execute one job, a plurality of pieces of biological information may be obtained by measurement at a plurality of time points (stages) in a series of operation periods concerning the one job (e.g., a period from the login time point for executing the job until the logout time point due to completion of execution of the job), and the plurality of pieces of biological information may be registered in association with the one job. For example, the plurality of pieces of biological information may be obtained by measurement at any two or more of the plurality of specific time points described above.

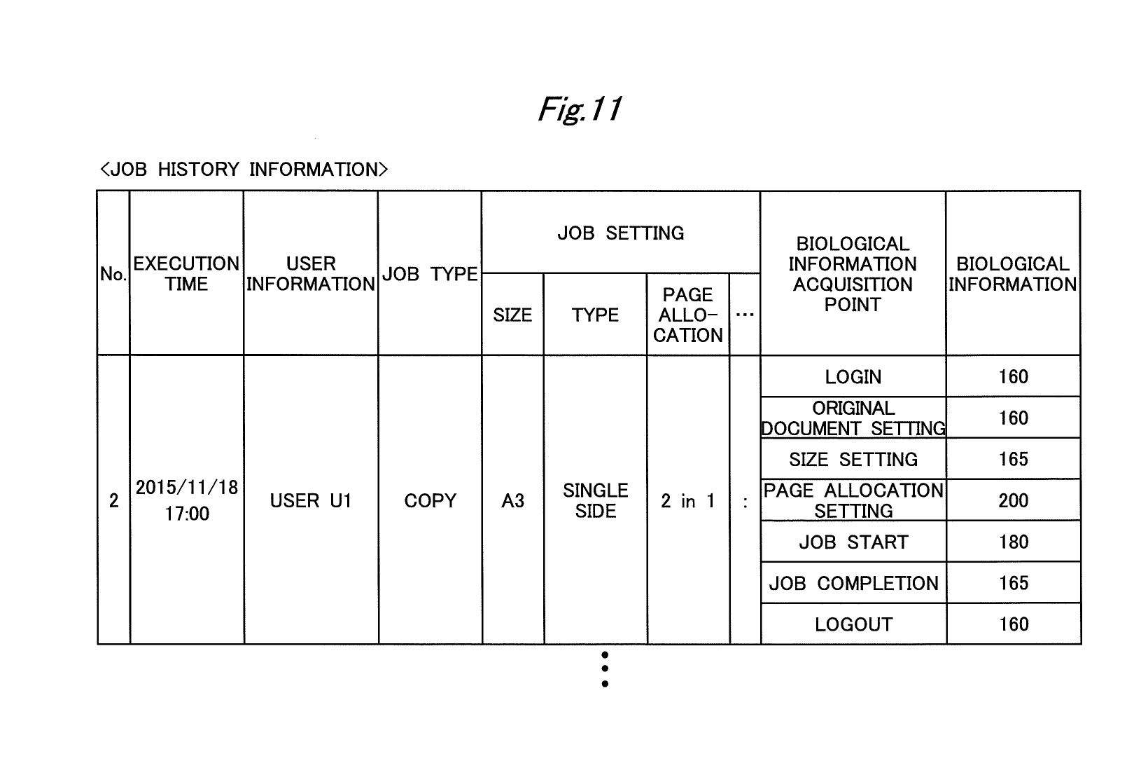

FIG. 11 shows another example of the job history information. As shown in FIG. 11, the job history information has information on the execution time of the job, the user who makes the MFP 10 execute the job, the job type, and the job setting, and also has the biological information acquired from the wearable terminal 50.

For example, FIG. 11 shows the following information on a job (copy job). Specifically, information (job information) concerning the job execution time (“2015/11/18 17:00”), the user who makes the MFP 10 execute the job (“user U1”), the job type of the job (“copy”), and the job setting of the job (e.g., paper size=“A3”, type=“single side (copy)”, page allocation=“2 in 1”) is registered.

In addition to the job information, a plurality of pieces of biological information obtained by measurement at different time points (stages) for one job are registered. Specifically, seven pieces of biological information obtained by measurement at seven different time points are registered in association with one copy job. The seven pieces of biological information are biological information at the login time point (step S11), biological information at the time of placing the original document (step S13), two pieces of biological information concerning the setting operation (step S14) (i.e., biological information at the time of the size setting operation, and biological information at the time of the page allocation setting operation), biological information at the copy start time point (step S15), biological information at the copy completion time point (step S16), and biological information at the logout time point (step S19). In this way, the seven pieces of biological information are “160”, “160”, “165”, “200”, “180”, “165”, and “160” in detail in order of time.

As described above, the biological information on the user (e.g., the user U1, the user U2, the user U3) who makes the MFP 10 execute the job is registered in association with each of a plurality of time points (stages) concerning the job (see FIG. 11). Therefore, information leading to job improvement can be easily collected. More specifically, the user's mental state and the like can be known at each time point (stage) concerning the job; therefore, it is possible to recognize the user's anxiety state and to analyze, for example, which stage of the job has a problem.

In particular, by accumulating such information with respect to a plurality of jobs (the same type or a plurality of types of jobs), characteristics, such as a general mental state, of the user at each time point (each stage) of the job can be grasped. In other words, by knowing the user's state in each type of job and/or each stage of the job, improvement points specific to the job type and/or job stage can be found.

When a plurality of pieces of biological information are obtained by measurement at a plurality of time points in a series of operation periods concerning one job, all of the plurality of pieces of biological information may not necessarily be associated with the one job.

For example, in a case where a plurality of pieces of biological information are obtained by measurement at a plurality of time points in a series of operation periods concerning one job, one piece of biological information among the plurality of pieces of biological information is registered, and at the same time, only the biological information in which a change equal to or more than a predetermined degree has occurred as compared to the biological information registered immediately before, among at least one piece of biological information obtained by measurement after the one piece of biological information may be registered in association with the one job. To put it shortly, only the biological information at the time when a relatively large change has occurred may be registered.

Specifically, in FIG. 11, the first obtained biological information (biological information at the login time) “160” is registered, and among the other six pieces of biological information obtained by measurement after the biological information at the login time, only the biological information in which a change equal to or more than a predetermined degree (e.g., “30”) has occurred as compared to the biological information registered immediately before may be registered. Specifically, biological information that does not cause a change of “30” or more with respect to the biological information “160” registered first (i.e., the biological information “160” at the time of original document placement and the biological information “165” at the time of size setting) is not registered, and biological information in which a change of “30” or more has occurred with respect to the biological information “160” at the time of login (i.e., the biological information “200” at the time of setting the page allocation) is registered next. The biological information in which the change of “30” or more has not occurred with respect to the registered biological information “200” (i.e., the biological information “180” at the start of the job) is not registered and the biological information in which the change of “30” or more has occurred with respect to the biological information “200” registered immediately before (i.e., the biological information “165” at the time of the job completion) is registered next. In addition, the biological information at the time of logout is not registered since it is biological information in which the change of “30” or more has not occurred with respect to the biological information “165” registered immediately before. As described above, only the biological information “160” at the time of login, the biological information “200” at the time of setting the page allocation, and the biological information “165” at the time of job completion may be registered among the seven pieces of biological information.

With this configuration, the number of data to be registered can be reduced.

Alternatively, when a plurality of pieces of biological information are obtained by measurement at a plurality of time points in a series of operation periods concerning one job, only the biological information having the largest difference from the normal value among the plurality of pieces of biological information may be registered. It should be noted that “normal value” may be measured and registered in advance for each user. Alternatively, an index value (e.g., an average value) of a general user may be registered as a normal value for each user.

Specifically, in FIG. 11, only the biological information “200” (i.e., the biological information “200” at the time of page allocation setting) having the largest difference from the normal value (e.g., “130”) may be registered among the seven pieces of obtained biological information. This also can reduce the number of data to be registered.

In the first embodiment, information concerning a job to be executed by one MFP is registered; however, the present invention is not limited thereto. A plurality of pieces of information concerning jobs to be executed by a plurality of MFPs may be registered. Specifically, for the respective jobs to be executed by the plurality of MFPs (in particular, a plurality of MFPs of different models), information on each job and biological information on each user may be registered in association with each other. By collecting information concerning a plurality of MFPs, more appropriate analysis can be performed. In particular, since the model information on the MFP is also registered in association with the job execution information, and job execution information in which information on a job concerning each of the MFPs of different models and biological information on each user are associated is collected while being distinguished for each model, whether there is an improvement point or the like for each model can be determined while being distinguished for each model. Further, since the job execution information including attribute information on the job (i.e., the job type information and/or the job setting information) is registered, problems for each job attribute (i.e., a job type and/or a job setting) can be determined while being further distinguished for each model.

### 2. Second Embodiment

A second embodiment is a modification example of the first embodiment. Hereinafter, differences from the first embodiment will be mainly described.

In the first embodiment, the technique that leads to improvement of the job by accumulating the job execution information (in particular, execution information on a relatively large number of jobs) and statistically analyzing the job execution information is mainly described; however, the present invention is not limited thereto.

In the second embodiment, a technique of immediately improving a job (in real time) using job execution information will be described.

In the second embodiment, the MFP 10 determines whether the state of the user differs by a predetermined degree or more from the usual state (normal state), on the basis of the biological information on the user obtained by measurement through the wearable terminal 50. More specifically, when the difference between the index value (biological information) measured during a series of operation periods concerning the job and the index value in the usual state of the user is equal to or more than a threshold value, it is determined that the state of the user differs by a predetermined degree or more from the usual state (normal state). The index value (biological information) in the usual state of the user may be measured and registered for each user in advance. Alternatively, an index value (e.g., an average value) of a general user may be registered as an index value in the usual state of each user.

When it is determined that the state of the user differs by a predetermined degree or more from the usual state, the MFP 10 outputs an attention attracting message to the user (performs display output in this embodiment).

Specifically, in a case where the biological information (e.g., a blood pressure) on the user who makes the MFP 10 execute the copy job is obtained by measurement at a specific timing concerning the copy job (e.g., at the time of instructing the copy start (step S15)), the following operation is executed when it is determined that the user has the uneasy mental state or the like, on the basis of the biological information on the user. That is, when a determination result indicating that the user has an uneasy mental state or the like is obtained, the MFP 10 displays a confirmation message such as “Are there no mistakes in the contents of the copy job?” on the operation panel part 6c (touch panel 25) (in, for example, step S16).

At the time of copying materials before the start of a meeting (or a presentation), the user may have a mentally unstable state (e.g., a state in which the blood pressure is higher than the normal value). Due to the fact that the user has a mentally unstable state (e.g., a state in which the blood pressure is higher than a normal value), the user may fall into a situation where the user easily makes an operation mistake or the like. In such a case, since the above-described confirmation message (attention attracting message) or the like is displayed on the MFP 10, the user can confirm whether the output result as intended has been obtained. With this configuration, the user can know the fact that a printed matter (copy) different from the original intention has been printed out due to a setting operation mistake or the like, before the start of the meeting.

Alternatively, in the case where the biological information on the user who makes the MFP 10 execute the print job is obtained by measurement at a specific timing concerning the print job, when the fact that the user has an unstable state or the like is determined on the basis of the biological information (e.g., a heart rate) on the user, the following operation is executed. That is, when a determination result indicating that the user has an unstable state (a state having a relatively high heart rate) or the like is obtained, the MFP 10 displays a confirmation message such as “Printed in haste, is everything all right?” on the operation panel part 6c (touch panel 25).

At the time of material printout just before the start of a meeting or the like, the user may run up the stairs and move to the place of the MFP on the upper floor to execute a printout of “confidential print job”. When the user has an unstable state (e.g., a state in which the heart rate is higher than the normal value), the user may fall into a situation where the user easily makes an operation mistake or the like. In such a case, since the above-described confirmation message (attention attracting message) and the like are displayed on the MFP 10, the user can confirm whether the output result as intended has been obtained. With this configuration, the user can know that a printed matter different from the original intention (e.g., a printed matter of another file) has been printed out due to a selection operation mistake or the like in the list screen concerning the confidential print before the meeting begins.

In this embodiment, an attention attracting message is displayed on the touch panel 25; however, the present invention is not limited thereto. The attention attracting message may be output as voice by a voice output part, the voice input/output control part 14, and the like of the MFP 10.

### 3. Modifications and Others

Although the embodiments of the present invention have been described above, the present invention is not limited to these embodiments.

For example, in each of the foregoing embodiments and the like, the biological information on the user is obtained by measurement at one or more specific stages for each job; however, the present invention is not limited thereto. The biological information on the user may be obtained by measurement at fixed time intervals (e.g., several to several tens of seconds) within a certain period of one job (e.g., the login period from the login time point until the logout time point or the period from the original document placing time point until the document retrieval time point). Moreover, a plurality of pieces of biological information obtained by measurement at fixed time intervals may be registered in association with the one job. Alternatively, a part of a plurality of pieces of biological information obtained by measurement at fixed time intervals (e.g., only one or more pieces of biological information in which a change of a predetermined degree or more has occurred as compared to the biological information registered immediately before, or only one piece of biological information with the largest difference from the normal value) may be registered in association with the one job.

In each of the foregoing embodiments and the like, the job history information (job execution information) is registered almost simultaneously in the MFP 10 and the server 80; however, the present invention is not limited thereto. The information concerning each job may be temporarily registered in the MFP 10 at the end of each job and may be registered in the server 80 at another timing thereafter. More specifically, the information concerning each job is temporarily stored in the MFP 10 at the end of each job, and thereafter, may be transmitted from the MFP 10 to the server 80 at a certain periodic transmission timing (e.g., at 22 o'clock every day) and may be stored in the server 80.

In each of the foregoing embodiments and the like, the job history information (job execution information) is registered in both the MFP 10 and the server 80; however, the present invention is not limited thereto. The job history information may be registered only one of the MFP 10 and the server 80.

Each of the foregoing embodiments and the like, the MFP 10 acquires biological information obtained by measurement through the wearable terminal 50 (wearable device) worn by the user U1 from the wearable terminal 50 via communication with the wearable terminal 50 (steps S21 to S23); however, the present invention is not limited thereto.

For example, the MFP 10 may acquire the biological information that has been obtained by measurement through the wearable terminal 50 worn by the user U1 and that has been transferred to and stored in the server 80, from the server 80 via communication with the server 80.

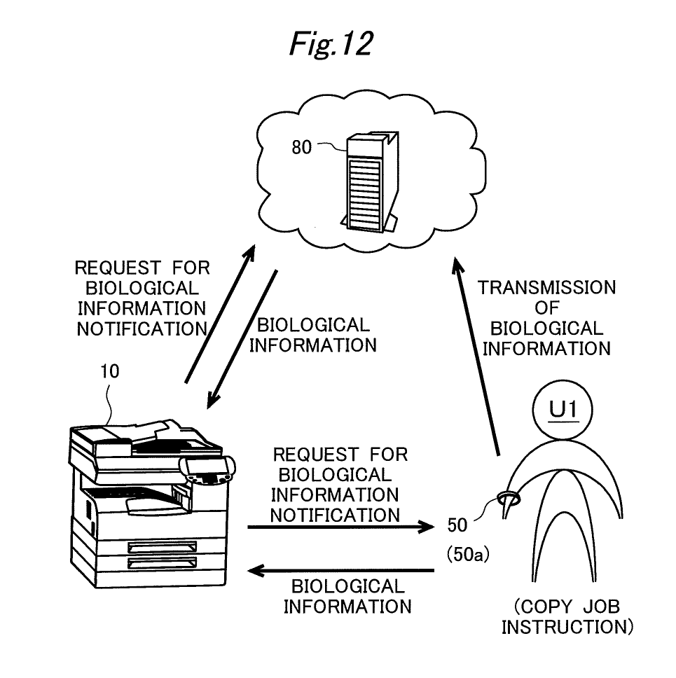

FIG. 12 shows such a modification example.

In this modification example, the wearable terminal 50 periodically transmits (transfers) the biological information obtained by measurement through the wearable terminal 50, to the server 80 (e.g., a cloud server) regardless of the presence or absence of a transmission request from the MFP 10. The server 80 distinguishes and stores the received biological information for each user.

On the other hand, the MFP 10 basically executes each job by performing the similar operations to those in FIGS. 5, 7, and 9. However, the MFP 10 transmits a transmission request of the biological information (i.e., the biological information notification request (steps S21, S41 and S61)) on the user U1 to the server 80 rather than the wearable terminal 50. The transmission request includes information on the user U1 (e.g., a user ID and a password), information on the measurement period for the biological information to be transmitted, and the like. The measurement period information includes information on a designated period that specifies the measurement time point (measurement period) for the biological information to be transmitted (i.e., information specifying the measurement period from one time point (start of the designated period) to another time point (e.g., the end of the designated period) for the biological information to be transmitted).

In receiving the transmission request, the server 80 extracts the biological information on the user U1 at a specific time point, from the biological information stored in the server 80, in accordance with the transmission request, and transmits the extracted biological information to the MFP 10. The MFP 10 receives and acquires the biological information on the user U1 from the server 80.

With this configuration as well, the MFP 10 can acquire the biological information on the user U1.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus comprising:
an acquisition part that acquires biological information on a user who makes the image processing apparatus execute a job, the biological information changing while reflecting a state of the user; and
a registration control part that controls an operation for registering information on the job and the biological information on the user in association with each other.

2. The image processing apparatus according to claim 1, wherein
the biological information is information that changes while reflecting a mental state and/or a physical condition of the user.

3. The image processing apparatus according to claim 1, wherein
the biological information includes information on at least one of a pulse wave, an electrocardiogram, a body temperature, a heart rate, and a blood pressure.

4. The image processing apparatus according to claim 1, wherein
the information on the job includes information on a type of the job, and
the registration control part registers the information on a type of the job and the biological information on the user in association with each other.

5. The image processing apparatus according to claim 1, wherein
the information on the job includes information on setting of the job, and
the registration control part registers the information on setting of the job and the biological information on the user in association with each other.

6. The image processing apparatus according to claim 1, wherein
the acquisition part acquires the biological information obtained by measurement at a specific stage in a series of operation periods concerning each job, and
the registration control part registers the biological information in association with each job.

7. The image processing apparatus according to claim 1, wherein
the acquisition part acquires a plurality of pieces of biological information obtained by measurement at a plurality of specific stages respectively in a series of operation periods concerning each job, and
the registration control part registers the plurality of pieces of biological information in association with each job.

8. The image processing apparatus according to claim 1, wherein
the acquisition part acquires one piece of biological information obtained by measurement at one time point in a series of operation periods concerning the job, and
the registration control part registers the one piece of biological information in association with the job.

9. The image processing apparatus according to claim 1, wherein
the acquisition part acquires a plurality of pieces of biological information obtained by measurement at a plurality of time points in a series of operation periods concerning the job, and
the registration control part registers the plurality of pieces of biological information in association with the job.

10. The image processing apparatus according to claim 1, wherein
the acquisition part acquires a plurality of pieces of biological information obtained by measurement at a plurality of time points in a series of operation periods concerning the job, and
the registration control part registers one piece of biological information among the plurality of pieces of biological information, and registers, in association with the job, only a piece of biological information in which a change equal to or more than a predetermined degree has occurred as compared to a piece of biological information registered immediately before, among at least one piece of biological information obtained by measurement after the one piece of biological information.

11. The image processing apparatus according to claim 1, wherein
the acquisition part acquires the biological information obtained by measurement of a wearable device worn by the user, from the wearable device through communication with the wearable device.

12. The image processing apparatus according to claim 1, wherein
the acquisition part acquires the biological information that has been transferred to a server after being obtained by measurement of a wearable device worn by the user and that is stored in the server, from the server through communication with the server.

13. The image processing apparatus according to claim 1, wherein
the registration control part transmits, to the server, job execution information in which the information on the job and the biological information on the user are associated with each other, and causes the server to store the job execution information.

14. The image processing apparatus according to claim 1, further comprising:
a determination part that determines whether a state of the user differs by a predetermined degree or more from a usual state, based on the biological information on the user; and
an output part that outputs an attention attracting message to the user when it is determined that the state of the user differs by the predetermined degree or more from the usual state.

15. A non-transitory computer-readable recording medium for recording a program that causes a computer built in an image processing apparatus to execute:
(a) acquiring biological information on a user who makes the image processing apparatus execute a job, the biological information changing while reflecting a state of the user; and
(b) controlling an operation of registering information on the job and the biological information on the user in association with each other.

16. An image processing system comprising:
an image processing apparatus; and
a server,
wherein
the image processing apparatus includes:
an acquisition part that acquires biological information on a user who makes the image processing apparatus execute a job, the biological information changing while reflecting a state of the user; and
a transmission part that transmits, to the server, job execution information in which information on the job and the biological information on the user are associated with each other, and
the server includes:
a reception part that receives the job execution information from the image processing apparatus; and
a storage part that stores the job execution information.
